(19) United States
(12) Patent Application Publication
(10) Pub. No.: US 2009/0273754 A1
(43) Pub. Date: Nov. 5, 2009

(54) I BAND

(76) Inventor: Rick Ridgeway, Mountlake Terrace, WA (US)

Correspondence Address: Karr Tuttle Campbell;ATTN: PRIYA SINHA CLOUTIER, 1201 Third Ave., Ste 2900, Seattle, WA, 98101, US

(21) Appl. No.: 12/115,035

(22) Filed: May 5, 2008

(51) Int. Cl. G02C 11/02

(52) U.S. Cl. 351/52

(57) ABSTRACT

The I BAND™ allows the wearer to vary the look of eyeglasses on a whim to match his/her clothes or accessories. Also, the I BAND™ can be used to cushion the area between the wearer's temples and the eyeglass arm. It also allows a manufacturer to increase its ability to market its logo/trademark by selling the I BAND™ or using it as promotional/marketing merchandise.

### CROSS-REFERENCES TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND

Eyeglasses, especially sunglasses and sports glasses, have become a fashion accessory over the years. Eyeglass wearers often have several pair of eyeglasses in different styles, colors, logos/trademarks, etc., allowing the eyeglasses to be matched with clothes, shoes handbags, among others. Eyeglasses, that are not prescriptive, can cost up to thousands of dollars a pair. Eyeglasses, that are prescriptive, start at approximately $200 per pair. Considering costs, it is cheaper for eyeglass wearers to limit the number of eyeglasses they own and find innovative means to modify them to match clothes, shoes, handbags, among others.

Information relevant to attempts to address these problems can be found in the following patents or patent applications: U.S. Pat. No. 389,853 (January 1988); U.S. Pat. No. 322,446 (December 1991); U.S. Pat. No. 5,440,355 (August 1995); U.S. Pat. No. 5,794,459 (August 1998); U.S. Pat. No. 6,027,213 (February 2000); U.S. Pat. No. 6,520,635 (February 2003). However, none of these references address the problems outlined above. Specifically, the current patent or patent applications do not allow eyeglasses to be matched according to color, trademark/logo, style, among others with the wearer's clothes or accessories. Further, the current patents or patent application are geared towards women and jewelry.

The current invention, known as the I BAND™ allows the wearer to vary the look of eyeglasses on a whim to match his/her clothes or accessories. Also, the I BAND™ can be used to cushion the area between the wearer's temples and the eyeglass arm. It also allows a manufacturer, business, or sports team, among others to increase its ability to market its logo/trademark by separately selling the current invention or simply giving it away as a promotional/marketing product.

### BRIEF SUMMARY OF THE INVENTION

The I BAND™ allows the wearer to vary the look of eyeglasses on a whim to match his/her clothes and/or accessories. It also allows a manufacturer, business, or sports team among others to increase its ability to market its logo/trademark by separately selling the I BAND™ so that it can be attached to eyeglasses.

### BRIEF DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is an elevation side view of the front side of the I BAND™;

FIG. 2 is an elevation side view of the back side f the I BAND™;

FIG. 3 is an elevation view of eyeglasses with I BAND™ attached.

### DETAILED DESCRIPTION OF THE INVENTION

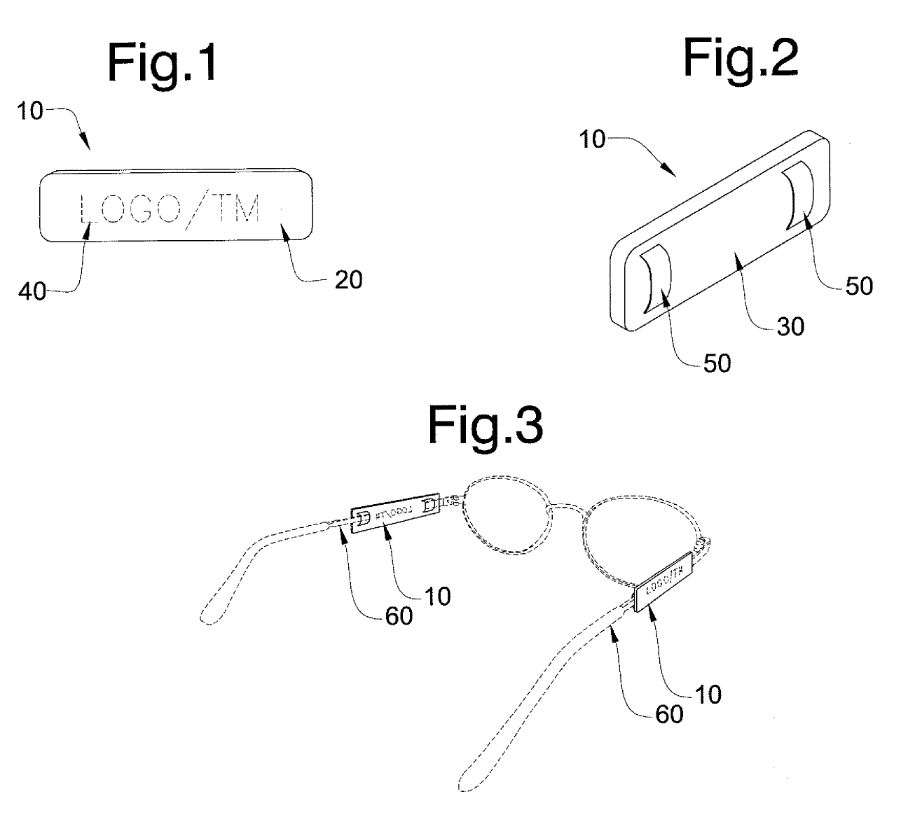

The present invention is described more fully hereinafter with reference to the accompanying drawings, in which preferred embodiments of the invention are shown. This invention may, however, be embodied in many different forms and should not be construed as limited to the embodiments set for herein; rather, these embodiments are provided so that this disclosure will be thorough and complete and will fully convey the scope of the invention to those skilled in the art. The following description refers to FIGS. 1 though 3.

The I BAND™ 10 can be composed of any material such as terry cloth, cotton, polyester, metal or composites thereof, and/or plastics, among others. The I BAND™ can be any of a plurality of colors and shapes. For purposes of simplifying this discussion a planar shape has been chosen. However, those skilled in the art will recognize that the shape of the I BAND™ can be produced any shape, size or color.

The I BAND™ 10 has a front side 20 and a rear side 30. The front side 20 can comprise any figure including, but not limited to, a logo or trademark 40. The front side 20 can also be plain; i.e. having no markings. The rear side 30 comprises a means to attach the I BAND™ 10 to eyeglasses. The means to attach can be Velcro™, snaps, and/or hooks, among others. In the preferred embodiment, the means to attach comprises at least two portions of elastic 50 attached to the inventive body. The means to attach can be held in place by glue, staples, and/or thread, among others.

The I BAND™ 10 is placed on at least one arm 60 on a pair of eyeglasses however, can also be worn on both arms 60. Further, multiple I BANDs™ can be worn in combination on one or both arms 60 of a pair of eyeglasses.

What is claimed:

1. An eyeglass accessory having a geometric shape, shaped as a car, shaped as an animal, shaped as sports equipment, or shaped as a cartoon character; said eyeglass accessory made of cloth; said eyeglass accessory having a front side and rear side; the rear side has at least one elastic band of such a size to allow the eyeglass accessory to slide over an arm of a pair of eyeglasses and hold the eyeglass accessory securely onto the arm.

2. (canceled)

3. (canceled)

4. (canceled)

5. (canceled)

6. (canceled)

7. (canceled)

8. (canceled)

9. (canceled)

10. (canceled)
